(19) United States
(12) Patent Application Publication
(10) Pub. No.: US 2026/0175886 A1
(43) Pub. Date: Jun. 25, 2026

(54) CONFIGURABLE STORAGE AND FULLFILLMENT CART

(71) Applicant: Pak-It Displays, LLC, ALEXANDRIA, VA (US)

(72) Inventor: Konrad Giersz, Philadelphia, PA (US)

(21) Appl. No.: 19/429,818

(22) Filed: Dec. 22, 2025

Related U.S. Application Data
(60) Provisional application No. 63/737,448, filed on Dec. 20, 2024.

(51) Int. Cl. B62B 3/00; A47B 81/00; B62B 3/02; B62B 5/06

(52) U.S. Cl. CPC B62B 3/005; A47B 81/00; B62B 3/02; B62B 5/06

(57) ABSTRACT

A configurable fulfilment cart having a first cart stage assembly and a second cart stage assembly. The first cart stage assembly has a first base, the first base having means for removably connecting the first base to a second base, a first rack removably connected to the first base, the first rack being configured to receive a plurality of containers, and a handle connected to the first base. The second cart stage assembly has a second base connected to the first base by the first means for removably connecting the first base to a second base, and a second rack removably connected to the second base, the second rack being configured to receive a plurality of containers.

### BACKGROUND OF THE INVENTION

### Field of the Invention

The present invention relates to staging and fulfilments carts.

### Brief Description of the Related Art

A variety of types of inventory carts and inventory management systems have been proposed and used.

For example, in U.S. Pat. No. 5,877,962, one or more inventory retrieval carts are provided, each cart having a number of containers suitable for receiving inventory picked from designated storage locations. Each cart has a display and communicates with the computer by radio transmission. According to the method multiple orders are received at the computer. Each order is assigned to a container on an assigned cart. The computer sends successive pick locations to the cart, and the cart operator fills the containers on the cart according to the symbol received from the computer.

U.S. Pat. No. 4,363,496 discloses a material handling cart which provides for the transportation and storage of material handling totes in manageable quantities. The material handling cart includes a pair of spaced parallel, vertical members interconnected by a plurality of equidistantly spaced horizontal support rails. A forwardly and downwardly projecting support leg is connected to each of the vertical members and terminates in a vertical portion remote from the connection to the vertical members. A first pair of fixed casters are mounted to the bottom of each of the vertical members and a second pair of rotatable casters are mounted in the ends of each of the vertical portions of the support legs. The material handling cart has curved handle portions and hand grips in order to maneuver the material handling cart.

In another example, U.S. Pat. No. 3,834,725 discloses a trolley adapted to hold or to exhibit things or articles of different kinds. The trolley has a plurality of vertically stacked tray-like horizontal containers which are connected to one another by three uprights. The upper and lower containers are fixed to the uprights and the intermediate containers are revolvable on bearings. The trolley has casters attached to each of the three uprights beneath the base container to permit the trolley to be rolled about on a horizontal surface. The trolley also allows for the attachment of accessories to customize the trolley to assist the operator in their task.

### SUMMARY OF THE INVENTION

In a preferred embodiment, the present invention is a configurable storage and fulfilment cart having a base with wheels and a multi-level rack the removably connects to the base. Each level of the multi-level rack can receive a basket or container in which items can be placed or stored. The base is configured such that a second base can be removably connected to it. In this manner multiple bases and racks can be connected to one another to allow the operator to create larger or smaller carts. Additionally, the bases are designed such that multiple bases can be stacked for storage or re-distribution in a warehouse or retail store. A handle may be connected to the base via a tab and/or rack to allow and operator to tow or push one or a plurality of racks. The system further may have an accessory board that attaches to a rack to allow an operator to have additional items available to them.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature and not as restrictive. Additional objects and advantages of the invention will be set forth in part in the description which follows and in part will be obvious from the description or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1A is a perspective view of a single storage and fulfilment cart in accordance with a preferred embodiment of the present invention.

FIG. 1B is a front view of a single storage and fulfilment cart in accordance with a preferred embodiment of the present invention.

FIG. 1C is a side view of a single storage and fulfilment cart in accordance with a preferred embodiment of the present invention.

FIG. 1D is a rear view of a single storage and fulfilment cart in accordance with a preferred embodiment of the present invention.

FIG. 1E is a top view of a single storage and fulfilment cart in accordance with a preferred embodiment of the present invention.

FIG. 2A is a perspective view of a base assembly of a storage and fulfilment cart in accordance with a preferred embodiment of the present invention.

FIG. 2B is a top view of a base assembly of a storage and fulfilment cart in accordance with a preferred embodiment of the present invention.

FIG. 2C is a front view of a base assembly of a storage and fulfilment cart in accordance with a preferred embodiment of the present invention.

FIG. 2D is a side view of a base assembly of a storage and fulfilment cart in accordance with a preferred embodiment of the present invention.

FIG. 3A is a perspective view of a single storage and fulfilment cart with an accessory board in accordance with a preferred embodiment of the present invention.

FIG. 3B is a front view of a single storage and fulfilment cart with an accessory board in accordance with a preferred embodiment of the present invention.

FIG. 3C is a side view of a single storage and fulfilment cart with an accessory board in accordance with a preferred embodiment of the present invention.

FIG. 3D is a rear view of a single storage and fulfilment cart with an accessory board in accordance with a preferred embodiment of the present invention.

FIG. 3E is a top view of a single storage and fulfilment cart with an accessory board in accordance with a preferred embodiment of the present invention.

FIG. 4 illustrates various features of an accessory board of a storage and fulfillment cart in accordance with a preferred embodiment of the present invention.

FIG. 5A is a perspective view of a single storage and fulfilment cart with an accessory board and loaded with baskets or containers in accordance with a preferred embodiment of the present invention.

FIG. 5B is a front view of a single storage and fulfilment cart with an accessory board and loaded with baskets or containers in accordance with a preferred embodiment of the present invention.

FIG. 5C is a side view of a single storage and fulfilment cart with an accessory board and loaded with baskets or containers in accordance with a preferred embodiment of the present invention.

FIG. 5D is a rear view of a single storage and fulfilment cart with an accessory board and loaded with baskets or containers in accordance with a preferred embodiment of the present invention.

FIG. 5E is a top view of a single storage and fulfilment cart with an accessory board and loaded with baskets or containers in accordance with a preferred embodiment of the present invention.

FIG. 6 is an assembly view of a single storage and fulfilment cart with an accessory board and loaded with baskets or containers in accordance with a preferred embodiment of the present invention.

FIG. 7A is a perspective view of a plurality of storage and fulfilment carts connected together in accordance with a preferred embodiment of the present invention.

FIG. 7B is a front view of a plurality of storage and fulfilment carts connected together in accordance with a preferred embodiment of the present invention.

FIG. 7C is a side view of a plurality of storage and fulfilment carts connected together in accordance with a preferred embodiment of the present invention.

FIG. 7D of a rear view of storage and fulfilment carts connected together in accordance with a preferred embodiment of the present invention.

FIG. 7E is a top view of a plurality of storage and fulfilment carts connected together in accordance with a preferred embodiment of the present invention.

FIG. 8A is a perspective view of a plurality of storage and fulfilment carts connected together with an accessory board connected to the lead cart in accordance with a preferred embodiment of the present invention.

FIG. 8B is a front view of a plurality of storage and fulfilment carts connected together with an accessory board connected to the lead cart in accordance with a preferred embodiment of the present invention.

FIG. 8C is a side view of a plurality of storage and fulfilment carts connected together with an accessory board connected to the lead cart in accordance with a preferred embodiment of the present invention.

FIG. 8D is a rear view of a plurality of storage and fulfilment carts connected together with an accessory board connected to the lead cart in accordance with a preferred embodiment of the present invention.

FIG. 8E is a top view of a plurality of storage and fulfilment carts connected together with an accessory board connected to the lead cart in accordance with a preferred embodiment of the present invention.

FIG. 9A is a perspective view of a plurality of storage and fulfilment carts connected together loaded with baskets or containers and with an accessory board connected to the lead cart in accordance with a preferred embodiment of the present invention.

FIG. 9B is a front view of a plurality of storage and fulfilment carts connected together loaded with baskets or containers and with an accessory board connected to the lead cart in accordance with a preferred embodiment of the present invention.

FIG. 9C is a side view of a plurality of storage and fulfilment carts connected together loaded with baskets or containers and with an accessory board connected to the lead cart in accordance with a preferred embodiment of the present invention.

FIG. 9D is a rear view of a plurality of storage and fulfilment carts connected together loaded with baskets or containers and with an accessory board connected to the lead cart in accordance with a preferred embodiment of the present invention.

FIG. 9E is a top view of a plurality of storage and fulfilment carts connected together loaded with baskets or containers and with an accessory board connected to the lead cart in accordance with a preferred embodiment of the present invention.

FIG. 10 illustrates various features of a base of a storage and fulfillment cart in accordance with a preferred embodiment of the present invention.

FIG. 11 illustrates various features of a handle of a storage and fulfillment cart in accordance with a preferred embodiment of the present invention.

FIG. 12 illustrates stacking and storage features of a storage and fulfillment cart in accordance with a preferred embodiment of the present invention.

FIG. 13 is a perspective view of a fully loaded multi-stage storage and fulfillment cart in accordance with a preferred embodiment of the present invention.

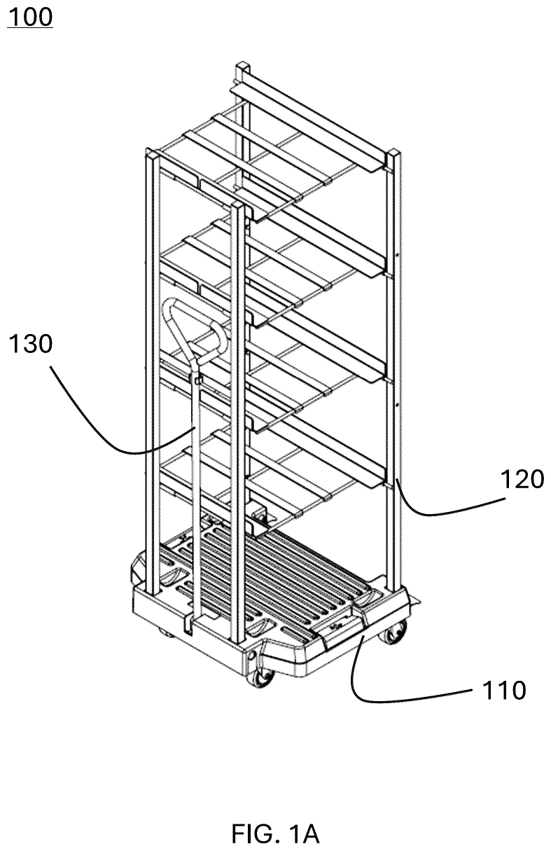

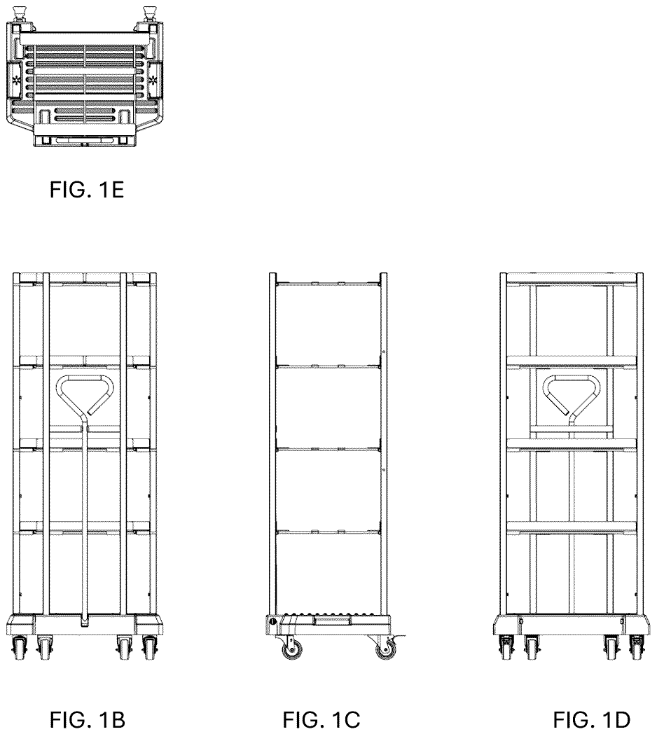

### DETAILED DESCRIPTION OF THE PREFERRED EMBODIMENTS

In a preferred embodiment, the present invention is a configurable storage and fulfilment cart 100 having a base assembly 110 and a multi-level rack 120 that removably connects to the base assembly 110.

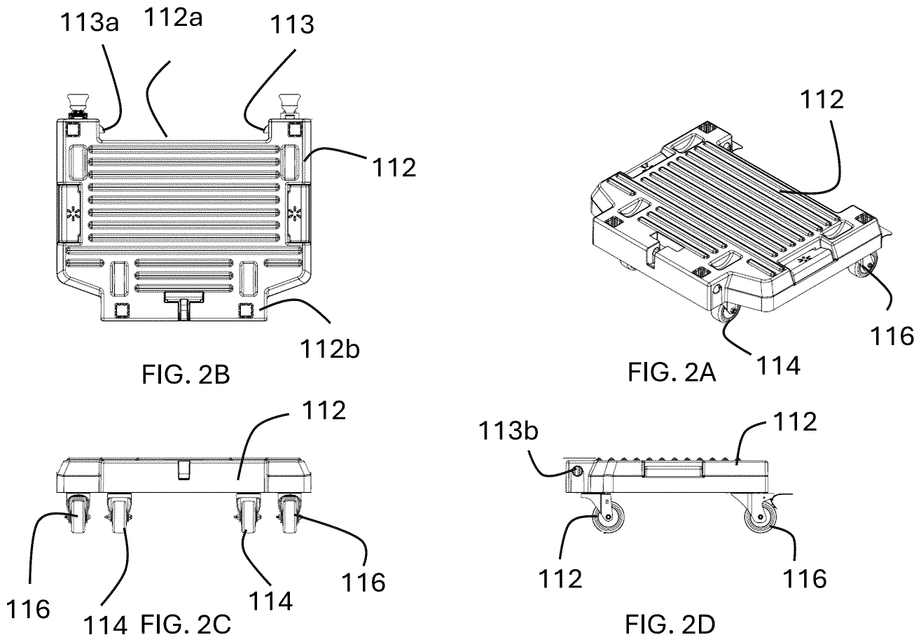

A preferred embodiment of the base assembly is shown in FIGS. 2A-2D. The base assembly 110 has an injection-molded base 112 with a pair of casters 114 and a pair of casters with breaks 116 connected to a bottom thereof. The base 112 has a rear offset portion 112a and a front narrow portion 112b such that the front narrow portion 112b of one base fits into the offset portion 112a of another base and means such as a pair of clips, biased posts, ball detents, or the like 113a snap in the recessed portion of second base snap into holes or recesses 113b in the narrow front portion 112b of the adjacent base to releasably connects the two bases together.

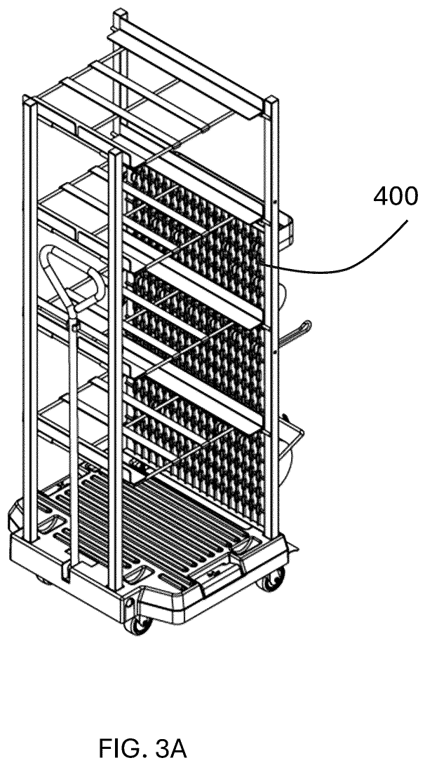

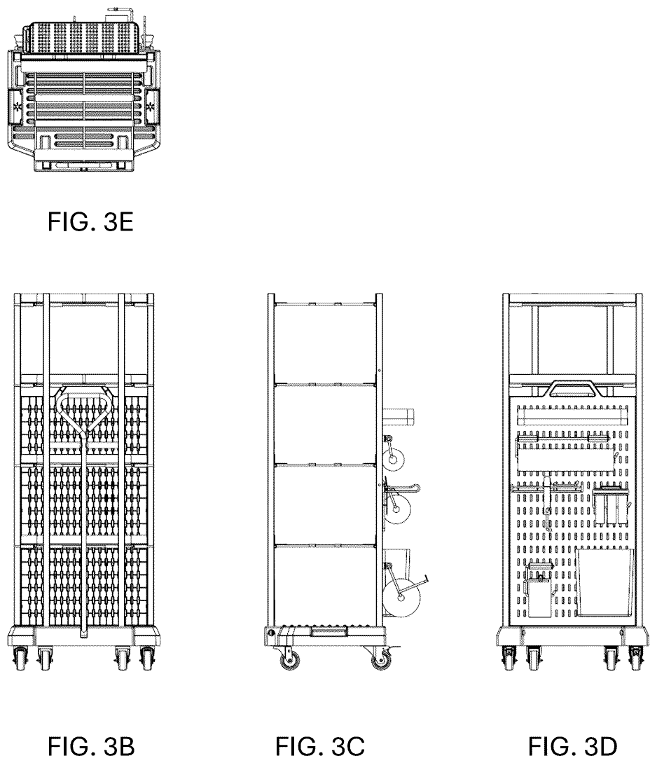

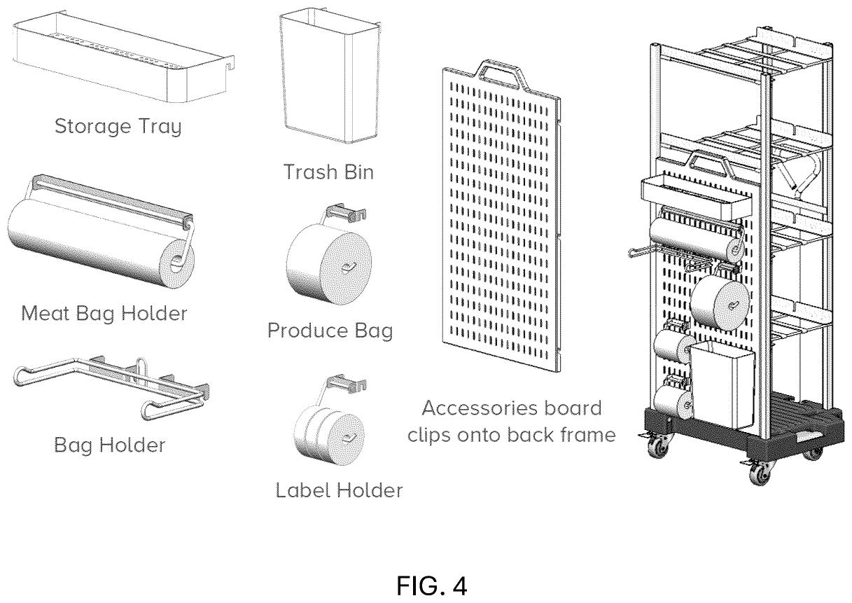

FIGS. 3A-3D and FIG. 4 show a single storage and fulfilment cart with an accessory board 400 in accordance with a preferred embodiment of the present invention. The accessory board 400 clips onto the back of the multi-level rack 120. A variety of accessories can be connected to the back side of the accessory board 400, including, for example, a storage tray, a meat bag holder, a bag holder, a trash bin, a produce bag roll, and a label holder.

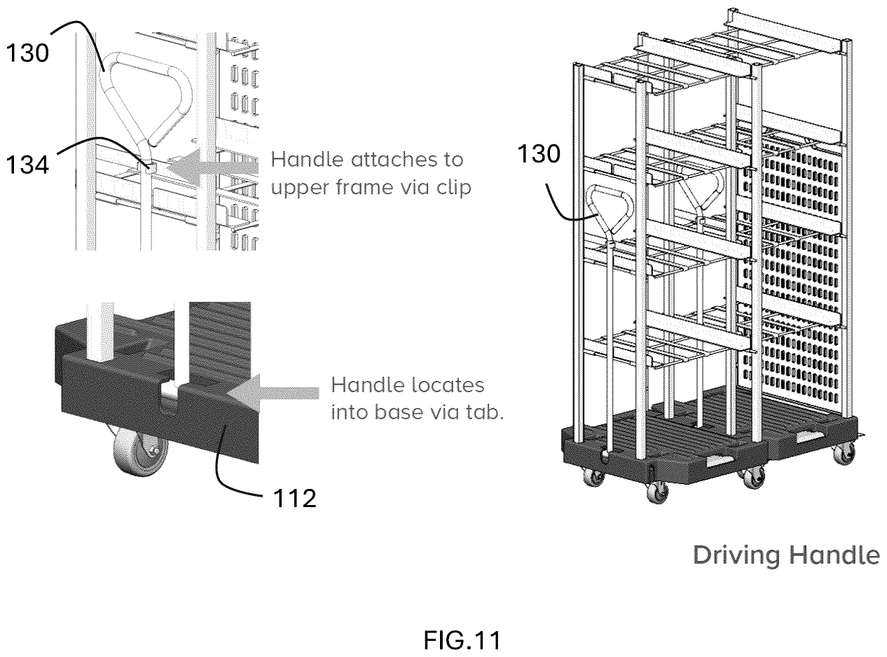

A handle 130 may be connected to the base 112 via a tab 132 as shown in FIG. 11 to allow for a user to maneuver the configurable storage and fulfilment cart. There further may be a clip 134 connected to the rack to hold the handle in a vertical position when the handle is not being used.

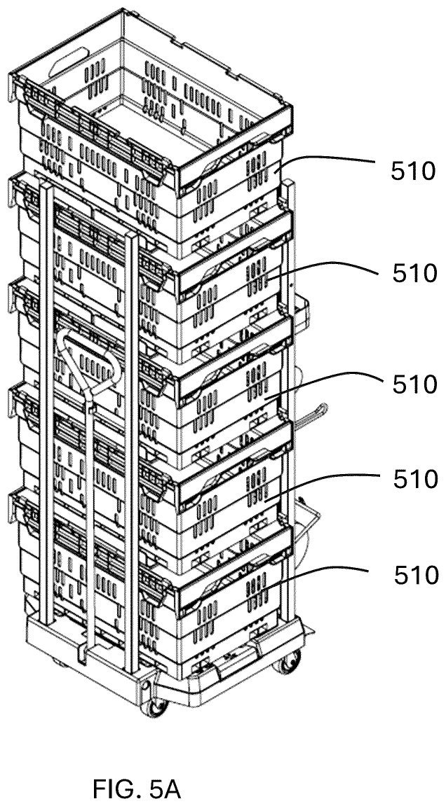

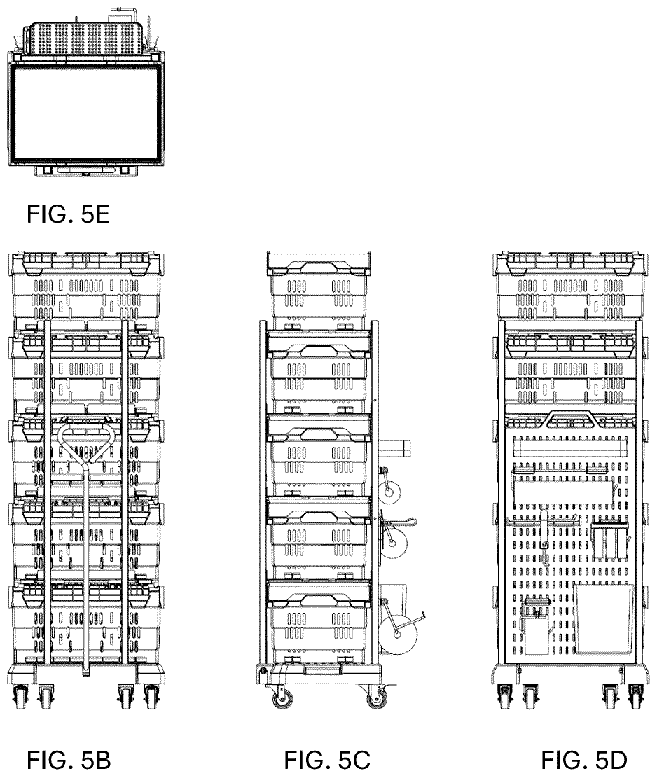

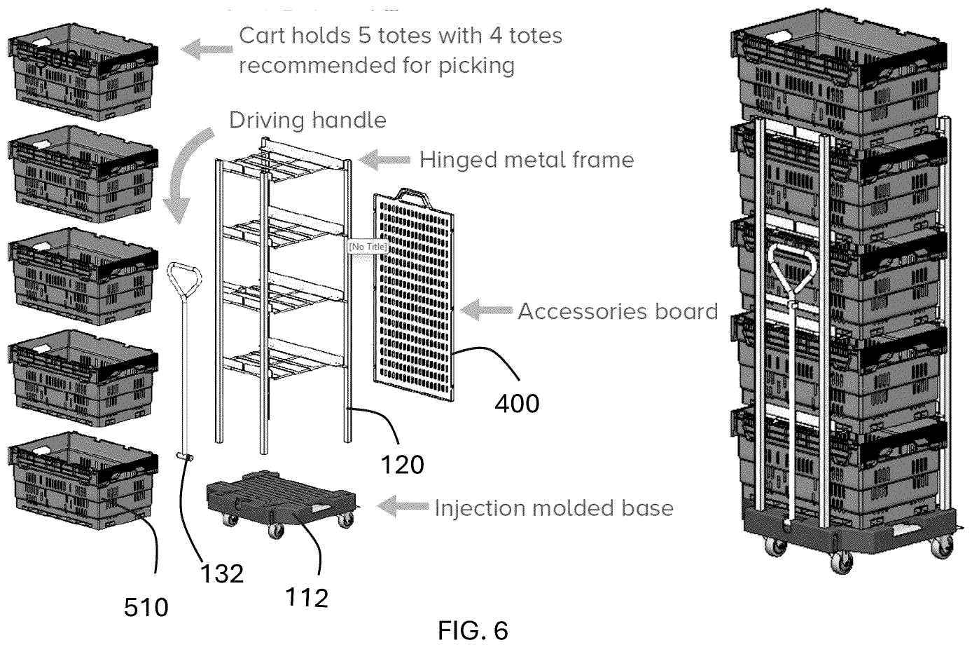

As shown in FIGS. 5A-5E and FIG. 6, each level of the multi-level rack 120 can receive a basket or container 510 in which items can be placed or stored.

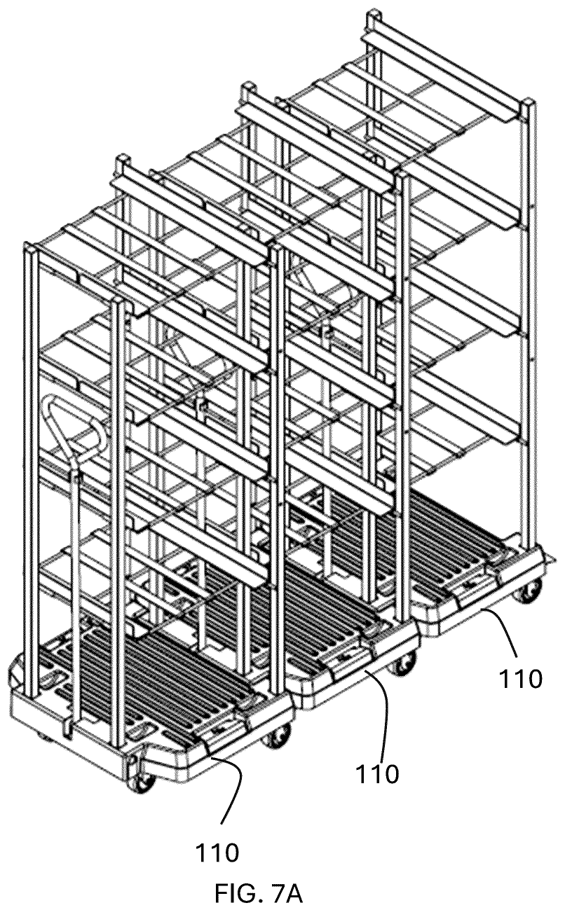

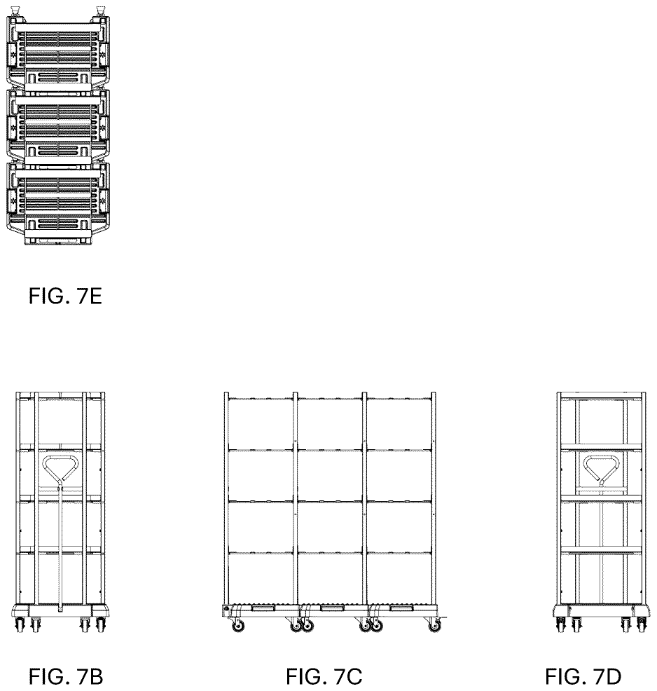

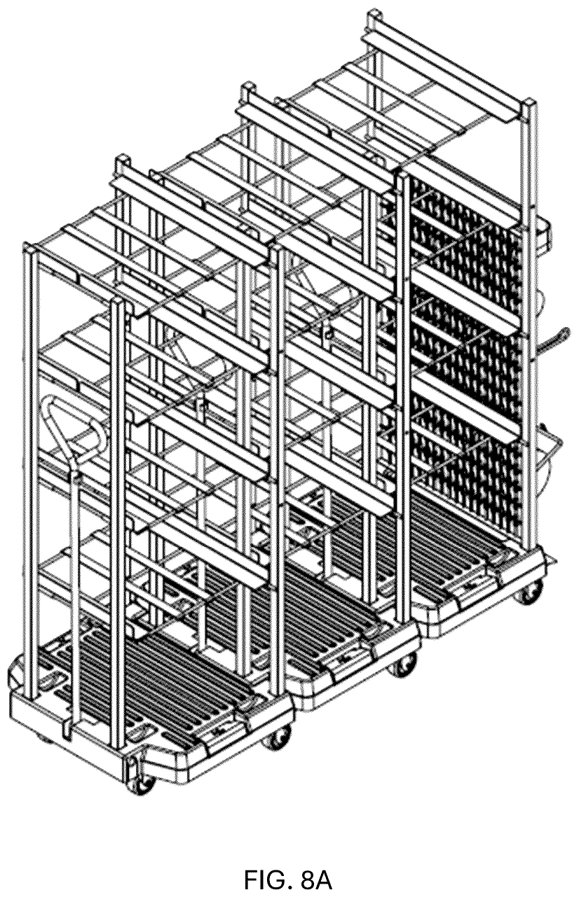

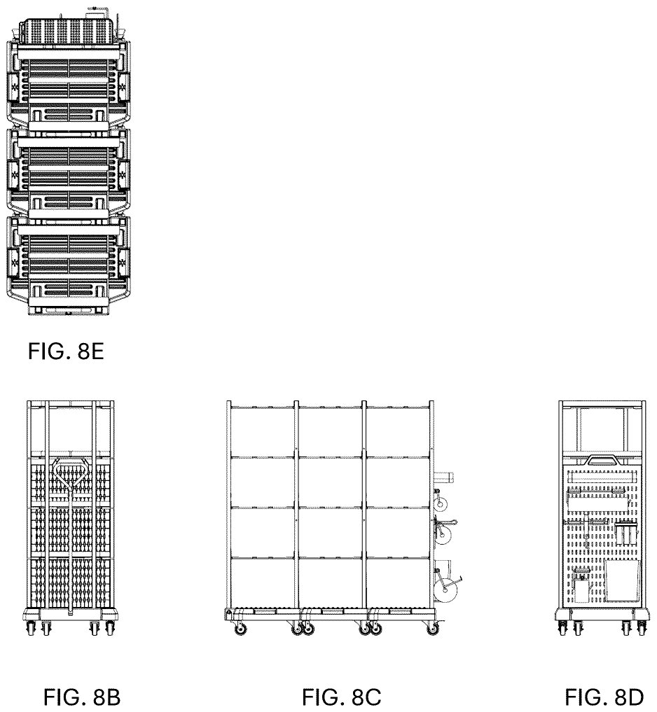

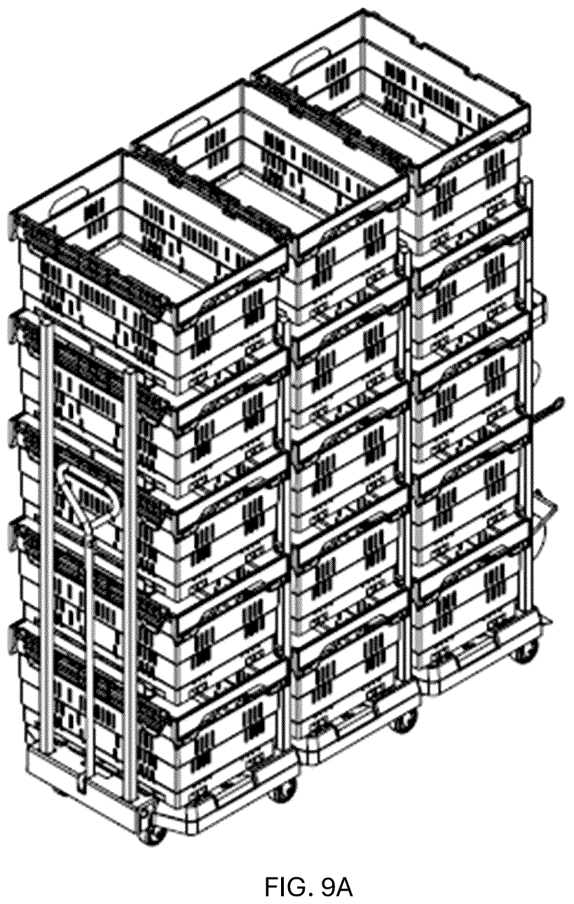

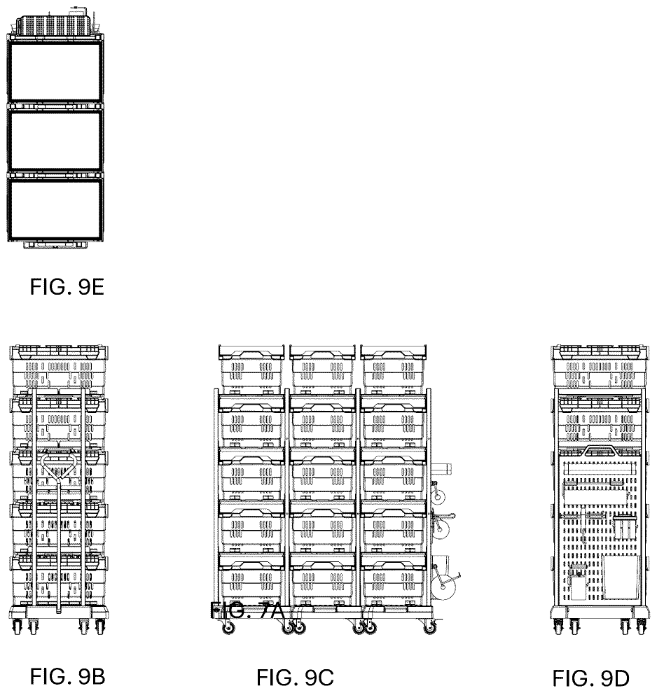

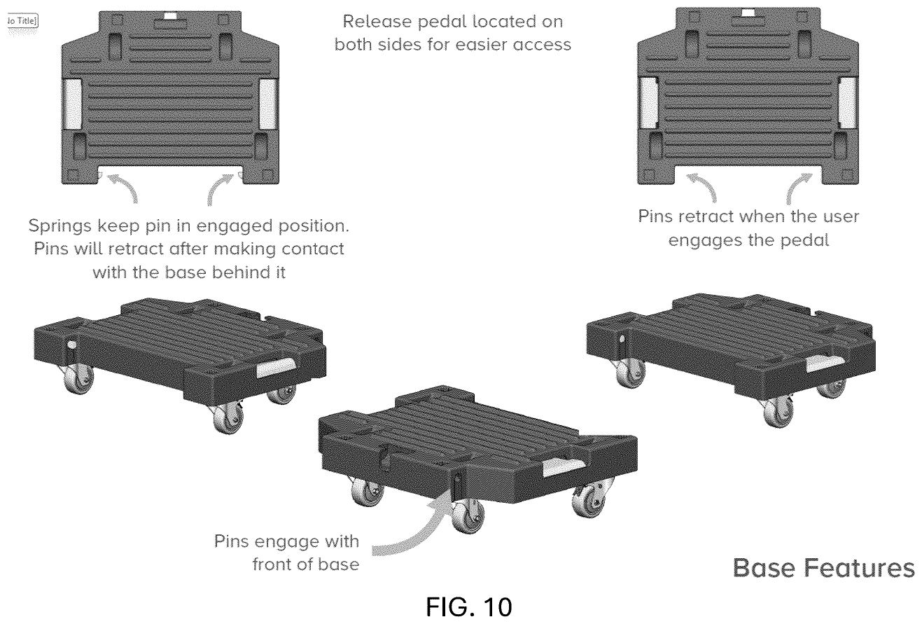

As shown in FIGS. 7A-7E, the base assembly 110 is configured such that a second base assembly 110 can be removably connected to it. In this manner multiple base assemblies 110 and racks 120 can be connected to one another to allow the operator to create larger or smaller carts.

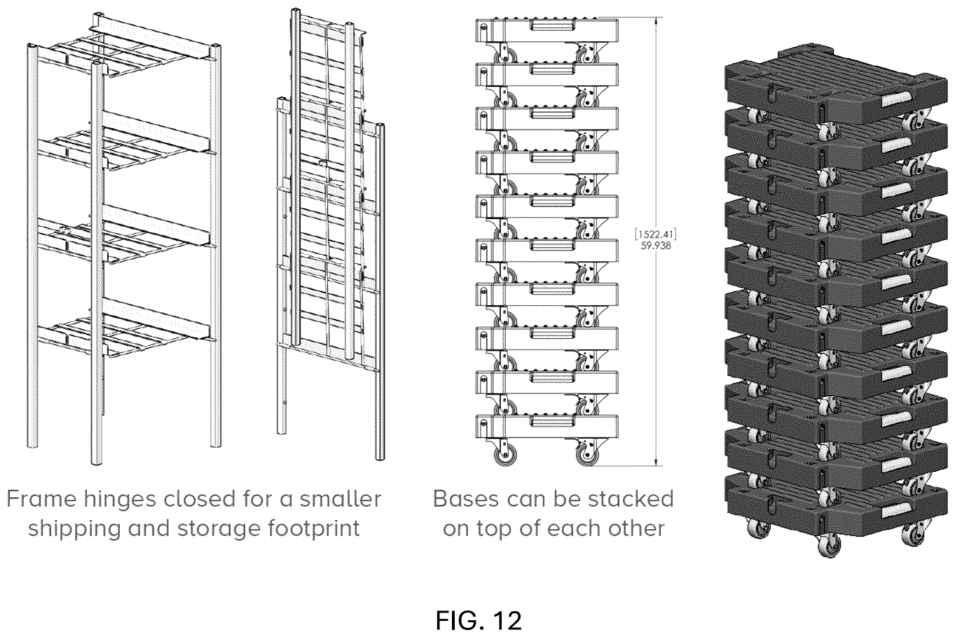

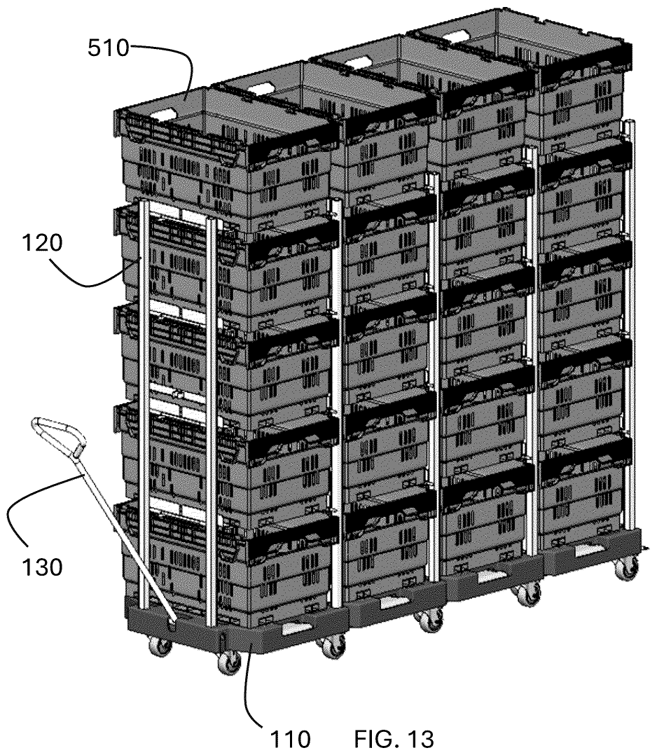

Additionally, the base assemblies 110 are designed such that multiple base assemblies 110 can be stacked for storage or re-distribution in a warehouse or retail store as shown in FIG. 12.

The racks may have hinged frames as shown in FIG. 12 to allow the frames to be closed to have a smaller shipping and storage footprint.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described to explain the principles of the invention and its practical application to enable one skilled in the art to utilize the invention in various embodiments as are suited to the particular use contemplated. It is intended that the scope of the invention be defined by the claims appended hereto and their equivalents. The entirety of each of the aforementioned documents is incorporated by reference herein.

What is claimed is:

1. A configurable fulfilment cart comprising:
a first cart stage assembly comprising:
a first base, said first base having means for removably connecting said first base to a second base;
a first rack removably connected to said first base, said first rack being configured to receive a plurality of containers; and
a handle connected to said first base;
a second cart stage assembly comprising:
a second base connected to said first base by said first means for removably connecting said first base to a second base; and
a second rack removably connected to said second base, said second rack being configured to receive a plurality of containers.

2. A configurable fulfilment cart according to claim 1 wherein said handle is removably connected to said first base.

3. A configurable fulfilment cart according to claim 1 wherein said second base has means for removably connecting said second base to a third base, said configurable fulfilment cart further comprising:
a third cart stage assembly comprising:
a third base connected to said second base by said second means for removably connecting said second base to a third base; and
a third rack removably connected to said third base, said third rack being configured to receive a plurality of containers.
